(19) United States
(12) Patent Application Publication
(10) Pub. No.: US 2001/0027912 A1
(43) Pub. Date: Oct. 11, 2001

(54) Multidirectional switch and operation unit using the same

(76) Inventors: Yoshiyuki Nakade, Fukui (JP); Shigeyoshi Umezawa, Fukui (JP); Naoaki Matsui, Fukui (JP); Hitokazu Shitanaka, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 09/804,228

(22) Filed: Mar. 13, 2001

(30) Foreign Application Priority Data
Mar. 15, 2000 (JP) 2000-071814

(51) Int. Cl. H01H 25/04

(52) U.S. Cl. 200/5 R; 200/6 A

(57) ABSTRACT

A multidirectional switch and an operation unit containing the switch, to be used for controlling an automobile air-conditioner, etc. Respective operating areas of an operation body are positioned at the middle area between push button switches. Therefore, a pressing force applied on an operating area causes a swaying motion with a swaying body and push means of swaying body push two switching contacts at substantially the same time, resulting in the electrical connection/disconnection. The configuration of the present invention eliminates such constituent components as coil spring, supporting pin, etc., yet it provides a inexpensive multidirectional switch that has a superior operational feeling with a less number of constituent components.

### FIELD OF THE INVENTION

The present invention relates to a multidirectional switch and an operation unit containing the switch, suitable application sector of which includes a control unit for an automobile air-conditioner or the like.

### BACKGROUND OF THE INVENTION

A conventional operation unit for controlling air-conditioner of an automobile has a panel as shown in FIG. 10; where, a number of push button switches 1 corresponding to respective functions are disposed within a frame 3, together with LED displays or the like means indicating the functions. Lately, automobiles have been equipped with varieties of additional functions; and a so-called multidirectional switch, which is capable of handling varieties of instructions in a single-body switch, has been increasingly used in the operation units, instead of using a plurality of single-function push button switches 1.

Such a multidirectional switch of the conventional structure is described in the following with reference to FIG. 11 through FIG. 13.

FIG. 11 is a cross sectional side view of a conventional multidirectional switch, FIG. 12 shows an exploded perspective view of the multidirectional switch.

As shown in FIG. 11 and FIG. 12, a cylindrical case 5 made of an insulating resin is provided with a boss 5A protruding upward from the center of bottom surface, and two protrusions 5B in the vicinity of the bass 5A.

A hole 5C of the boss 5A houses a supporting pin 7, which is pushed upward by a slightly compressed coil spring 6, the upper end of which supporting pin 7 having a spherical surface.

A wiring board 8 having a plurality of conductive patterns (not shown) on both of the surfaces is provided with five push button switches 9A-9E on the upper surface, which are being disposed in a radial arrangement around a central through hole 8A and fixed thereon by soldering or the like means and perform the electrical connection/disconnection in accordance with a pressing operating force, accompanying a click feeling.

The wiring board 8 is fixed with two screw bolts 10 on the protrusions 5B of case 5, with the through hole 8A penetrated by the boss SA of case 5.

The wiring board 8 is coupled with lead wires 11 at one end by soldering, or using a conductive adhesive, and the lead wires 11 are connected via conductive pattern with respective push button switches 9A-9E.

The lead wires 11 are led out of the case 5 through a cut 5D, to be electrically connected at the other end with an electronic circuit (not shown) of an automobile.

A swaying body 12 made of an insulating resin is provided just above the wiring board 8. The swaying body 12 is provided with an operating axle 12B protruding upward from the center of the upper surface of a bowl part 12A.

Provided at the center of the lower surface of the bowl part 12A is a clicking void 12C, which has an elastic contact with the supporting pin 7 at the upper end. The bowl part 12A is provided with five push sections 12D-12H stretching in a radial arrangement from the outer circumference. The tip ends of the push sections are making contact at the bottom surface on the upper surface of the push button switches 9A-9E.

A cover 13 covering the case 5 from the above is provided on the upper surface with varieties of markings, painted by a printing process or the like method. An opening 13A is provided at the center, and a contact portion 13B of a spherical shape is provided at the lower part of the opening 13A.

The swaying body 12, which is pushed upward by the supporting pin 7, makes contact at the upper surface of the bowl part 12A with the contact portion 13B. Thus the swaying body 12 is supported by the supporting pin 7 at the upper end, so that it can sway around the upper end.

An operation body 14 has an operating area 14A of a flange shape on the upper surface and a coupling section 14B protruding downward from the center of the lower surface. The coupling section 14B is inserted through the opening 13A of cover 13 to be coupled and fixed with the operating axle 12B of swaying body 12. A conventional multidirectional switch is thus constituted.

In the above-configured multidirectional switch, when the operation body 14 is pressed to a certain specific direction, for example, when the operating area 14A is pressed downward at the left end the swaying body 12 sways to the left with the upper end of the supporting pin 7 as the fulcrum point so that the bottom end surface of the push section 12D pushes the pushbutton switch 9A down. Then, the push-button switch 9A is brought into an electrical connection.

At this time, as a result of swaying of the swaying body 12, the push sections 12E, 12H locating next to the push section 12D also move slightly downward to press the push-button switches 9B, 9E locating next to the push-button switch 9A. Since the loads of pressing the push-button switches 9B, 9E are added on that of the push-button switch 9A, click feeling of the push-button switch 9A itself is deteriorated.

However, as a result of the swaying motion of swaying body 12 the point of making contact between the upper end of the supporting pin 7 and the clicking void 12C shifts, which results in a change in the amount of flexion with the coil spring 6. This generates a click feeling corresponding to the amount of load drop P1 as exhibited in FIG. 13, an operational characteristics chart.

In the conventional multidirectional switches of the above-described configuration, the coil spring 6 and the supporting pin 7 are the essential components for generating the click feeling; which means an increased number of constituent components. Furthermore, the click feeling of the push-button switch 9A itself, which makes electrical connection/disconnection in accordance with a pressing operation, is deteriorated, resulting in a reduced amount of the load drop P1. Thus, it has been difficult to provide a satisfactory operational feeling with the conventional multidirectional switches.

### SUMMARY OF THE INVENTION

A multidirectional switch of the present invention has an operation body comprising a plurality of operating areas, each of the operating areas is positioning at a middle area between contact switches. A pressing force applied on the operation body sways a swaying body, bringing two contact switches into electrical connection/disconnection at substantially the same time. With the above-described structure, where push means of the swaying body press two contact switches at substantially the same time, a superior feeling of operation is generated without needing such constituent components as coil spring, supporting pin or the like. Thus the present invention provides an inexpensive multidirectional switch that is formed of less number of component counts, and provides a superior feeling of operation.

### BRIEF DESCRIPTION OF THE DRAWINGS

FIG. 1 is a cross sectional side view of a multidirectional switch in accordance with a first exemplary embodiment of the present invention.

FIG. 2 shows an exploded perspective view of the multidirectional switch.

FIG. 3 is a plan view of the multidirectional switch.

FIG. 4 is a cross sectional side view of the multidirectional switch at operation.

FIG. 5 shows operational characteristics of the multidirectional switch.

FIG. 6 is a cross sectional side view of a multidirectional switch in accordance with a second exemplary embodiment of the present invention.

FIG. 7 shows an exploded perspective view of the multidirectional switch.

FIG. 8 shows a perspective view of a push structure of the multidirectional switch.

FIG. 9 shows a perspective view of an operation unit containing the multidirectional switches.

FIG. 10 shows front view of a conventional operation unit.

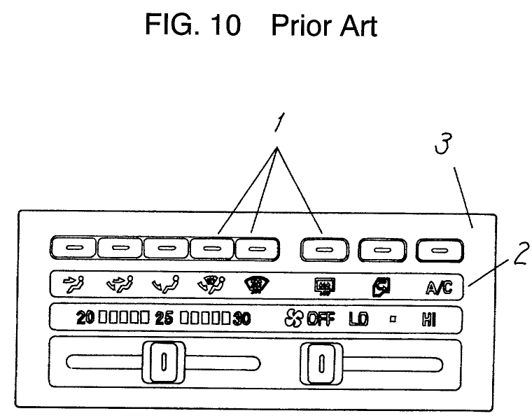

FIG. 11 is a cross sectional side view of a conventional multidirectional switch.

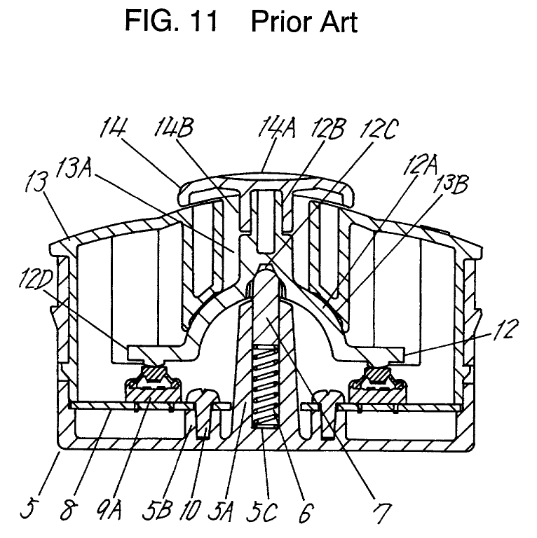

FIG. 12 shows an exploded perspective view of a conventional multidirectional switch.

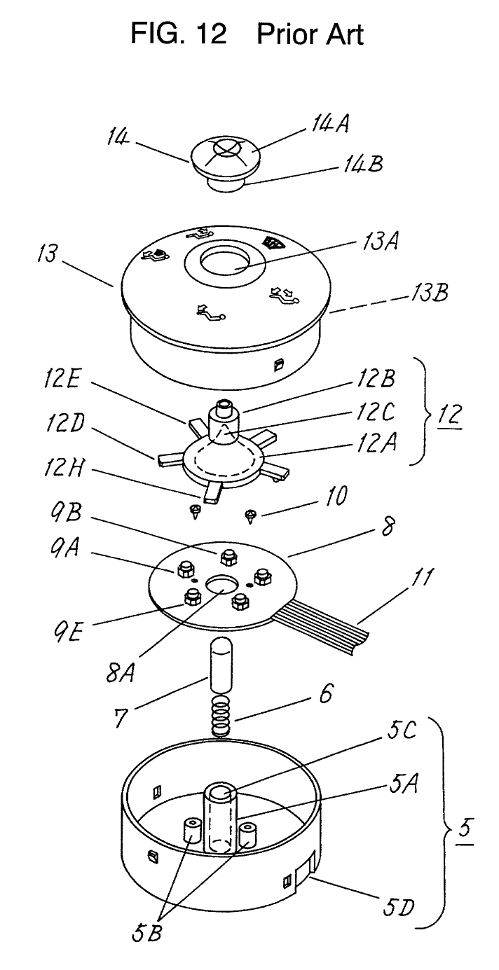

FIG. 13 shows operational characteristics of the conventional multidirectional switch.

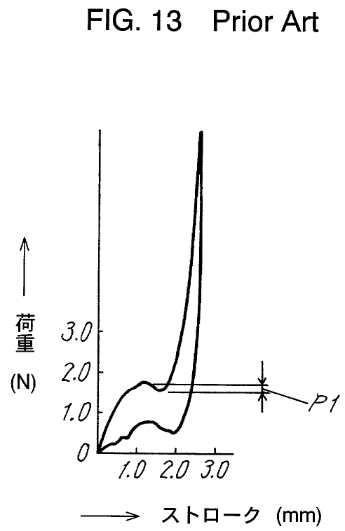

### DESCRIPTION OF THE PREFERRED EMBODIMENTS

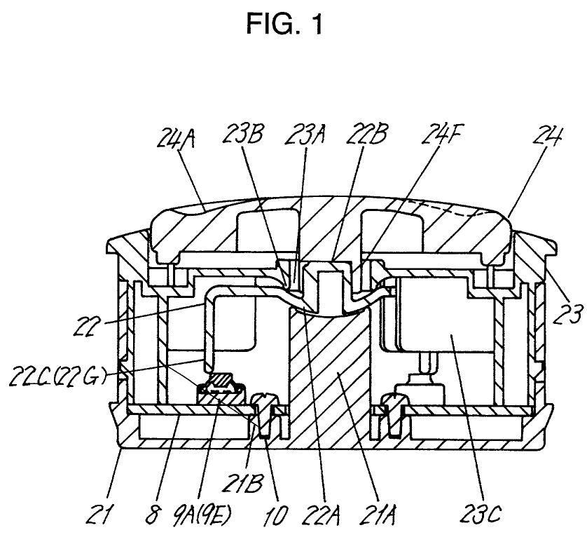

Referring to FIG. 1 through FIG. 9, exemplary embodiments of the present invention are described in the following.

Those constituent portions identical to those of the conventional multidirectional switch described earlier in BACKGROUND OF THE INVENTION are represented by putting the same symbols, and detailed descriptions of which are omitted.

First Embodiment

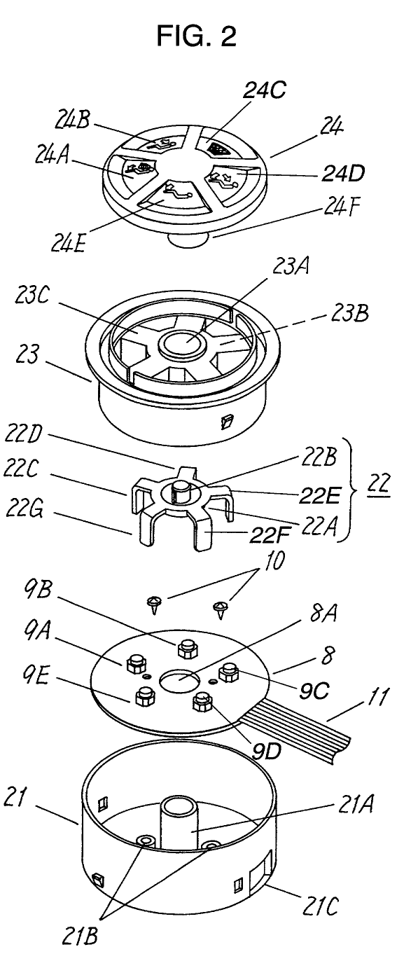

As shown in FIGS. 1 and 2, a cylindrical case 21 made of an insulating resin is provided with a support 21A protruding upward from the center of the bottom, the top end of support 21A has a recessed surface, and two protrusions 21B are disposed in the vicinity of the support 21A.

A wiring board 8 having a plurality of conductive patterns (not shown) on both surfaces is provided on the upper surface with five push button switches 9A-9E disposed in a radial arrangement around a central through hole 8A, fixed thereon by soldering or the like means. The push button switches performs as a result of pressing operation the electrical connection/disconnection accompanying a click feeling.

The wiring board 8 is fixed with two screw bolts 10 on the protrusions 21B of case 21, with the through hole 8A inserted by the support 21A of case 21.

The wiring board 8 is coupled with lead wires 11 at one end by soldering, or using a conductive adhesive and the lead wires 11 are connected via conductive pattern with respective push button switches 9A-9E. The lead wires 11 are led out of the case 21 through a cut 21C, to be electrically connected at the other end with an electronic circuit (not shown) of an automobile.

A swaying body 22 made of an insulating resin is provided just above the wiring board 8, in a manner that a bowl portion 22A at the center of the lower surface is held on the support 21A of case 21 so that it can sway. The swaying body 22 is provided with an operating axle 22B protruding upward from the center of the upper surface of the bowl portion 22A.

Stretching in a radial arrangement from the outer circumference of bowl portion 22A are five push sections 22C-22G, the tip end of which is making contact with the upper surface of the push button switches 9A-9E.

The case 21 is covered from the above with a cover 23, which is provided with an opening 23A at the center, and surrounding the opening 23A is a contact portion 23B. The upper surface of the bowl portion 22A of the swaying body 22 is having a contact with the contact portion 23B. The push sections 22C-22G are housed in and supported respectively by five guide portions 23C so that the swaying body 22 does not revolve.

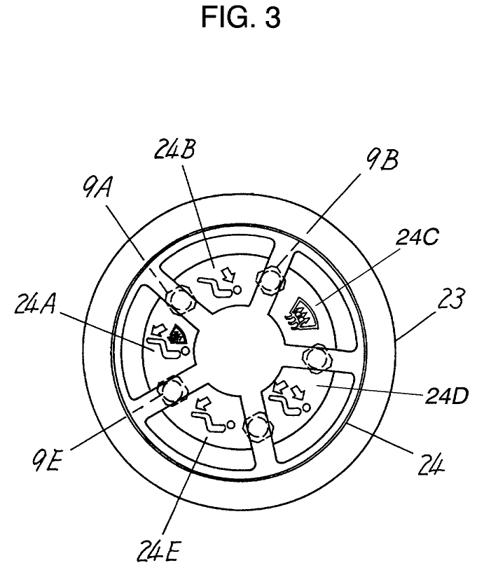

An operation body 24, which has five slightly recessed operating areas 24A-24E on the upper surface, is disposed so that each of the respective operating areas 24A-24E is positioned in the middle region between the push button switches among 9A-9E, as shown in FIG. 3. The upper surfaces of the operating areas 24A-24E are provided with various markings given by a printing process or the like means.

A coupling section 24F protruding from the center of the lower surface of the operation body 24 is inserted through the opening 23A of cover 23 to be coupled with the operating axle 22B of the swaying body 22, in a manner they do not revolve with each other. A multidirectional switch of the present invention is thus constituted.

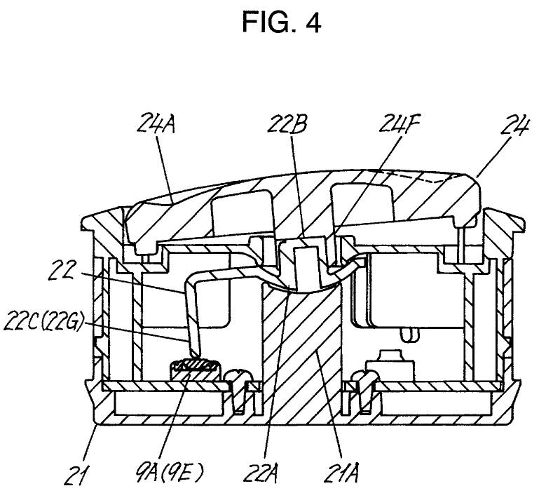

Under the above-described configuration, when the operation body 24 is pressed to a certain specific direction; for example, when the operating area 24A locating at the left end is pressed downward the swaying body 22, which is hooked at the operating axle 22B by the coupling section 24F of the operation body 24, sways to the leftward, as shown in FIG. 4, around the bowl section 22A which works as the falcrum. The push sections 22C and 22G locating respectively at the middle region between the operating areas push at their tip ends the push button switches 9A and 9E at substantially the same time, bringing the push button switches into electrical connection/disconnection.

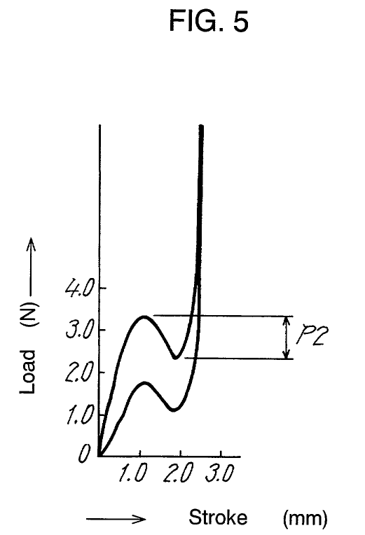

At this moment, an operator perceives through the operation body 24 a substantial click feeling of operation that corresponds to the considerable amount of load drop P2 shown in FIG. 5. The substantial amount of click feeling of operation originates from the click feelings generated by the two push switches 9A and 9E. The signals of electrical connection/disconnection generated from the two push button switches 9A, 9E are transmitted to an electronic circuit of an automobile through the lead wires 11 connected with the wiring board 8.

When the operation body 24 is pressed in other directions, namely when either one of the operating areas 24B-24E is pressed downward, two of the push button switches among 9A-9E are pressed at substantially the same time by the corresponding swaying body 22's push sections among 22C-22G locating at the middle regions. The electrical connection/disconnection is thus performed.

In a multidirectional switch in accordance with the present embodiment, each of the operating areas 24A-24E of the operation body 24 is located at the middle region between the plurality of push button switches 9A-9E. Operating pressure applied on one of the operating areas causes a sway with the swaying body 22, and some of the push sections among 22C-22G bring two of the switching contacts into connection at substantially the same time. With the above-described configuration, such constituent components as the coil spring, the supporting pin or the like can be eliminated, and multidirectional switches that are inexpensive yet providing a superior feeling of operation are provided.

Second Embodiment

A second exemplary embodiment of the present invention is described below. Those portions having the same structure as in the first embodiment are indicated by the same symbols.

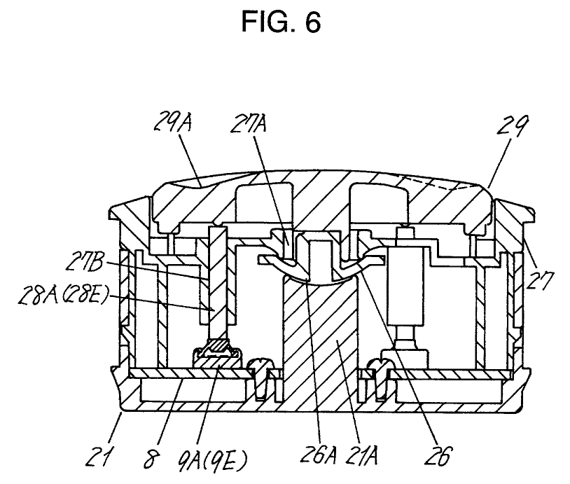

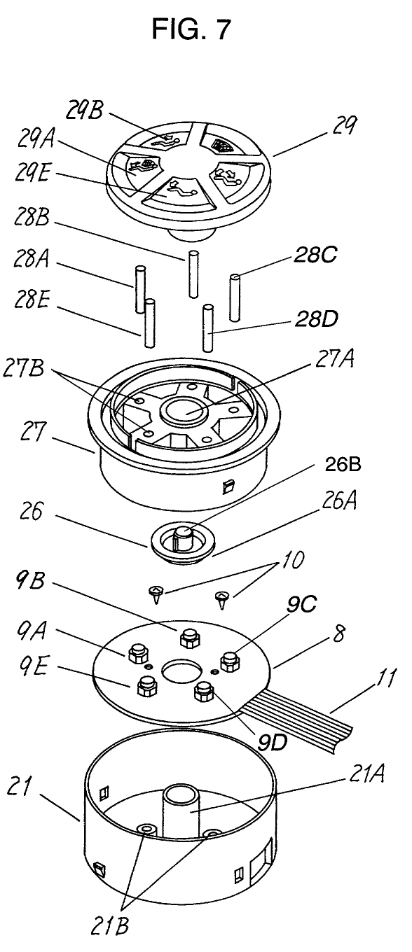

Referring to FIGS. 6 and 7, as in the same manner with the first embodiment, a cylindrical case 21 is provided with a support 21A, which is protruding from the center of the bottom and the upper end of which has a recessed surface. And a wiring board 8 having five push button switches 9A-9E disposed on the upper surface in a radial arrangement is also fixed on the case 21.

Also in the same way as in the first embodiment, a swaying body 26 having an operating axle 26B at the center of the upper surface is placed in the case 21 so that it can make a swaying motion, with a bowl portion 26A of the swaying body 26. The bowl portion 26A is at the center of the lower surface of the swaying body, supported on the support 21A of case 21. However, in the present embodiment, the swaying body 26 is not provided with a push section. Instead, a cover 27 is provided with five through holes 27B disposed in a radial arrangement around an opening 27A locating at the center. Five column-shaped push members 28A-28E are disposed inserted in the respective through holes 27B so that they can slide ups and downs in the through hole with the bottom ends making contact with the upper surface of the push button switches 9A-9E.

The column-shaped push members 28A-28E are making contact at the upper end with the lower surface of an operation body 29 at the middle regions between respective five operating areas 29A-29E. These push members move ups and downs in accordance with the pressure given by an operation body 29. A multidirectional switch in a second embodiment is thus formed.

Under the above-described configuration, when the operation body 29 is pressed to a certain specific direction; for example, when the operating area 29A locating at the left end is pressed downward, the push member 28A, whose upper end is being pressed by the lower surface at the middle region between the operating areas 29A and 29B, and the push member 28E, whose upper end is being pressed by the lower surface at the middle region between the operating areas 29A and 29E, move downward within the through holes 27B. The lower ends of the respective push members 28A and 28E push the push button switches 9A and 9E at substantially the same time, bringing the push button switches into electrical connection/disconnection.

At this moment, an operator perceives a superior feeling of operation that originates from the click feelings of the respective two push button switches 9A and 9E. The signals of electrical connection/disconnection generated from the two push button switches 9A, 9E are transmitted to an electronic circuit of an automobile through the lead wires 11, which have been connected with the wiring board 8.

When the operation body 29 is pressed to other directions, two of the push button switches among 9A-9E are pressed at substantially the same time. Thus, the electrical connection/disconnection is performed in the same manner as in the first embodiment.

As described above, a multidirectional switch of the present embodiment is provided with pressing members 28A-28E that move up and down when the upper end is pressed by the operation body 29 at the lower surface. In a structure where a plurality of switch contacts are brought into electrical connection/disconnection by a straight-line motion of push members, a more reliable operation in the switching contact can be expected. In addition, it provides a clearer operational feeling of clicking.

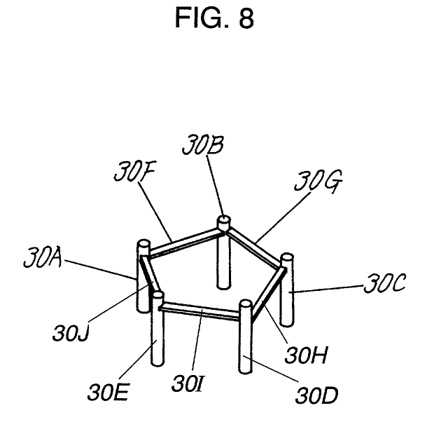

Assembly of the multidirectional switches can be made easier, by providing a plurality of push members 30A-30E in the form of a unitized component connected by means of thin and flexible arms 30F-30J into one piece, as shown in FIG. 8.

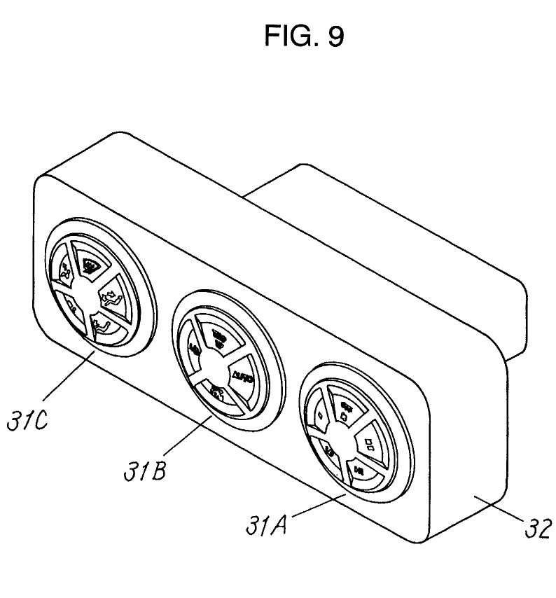

As shown in a perspective view of FIG. 9, a plurality of the multidirectional switches 31A, 31B and 31C, described in the above first and embodiments, may be mounted on a framework 32 with the operation bodies of the switches facing front. Where, for example, the switch 31A may be assigned, for example, to the control of the amount of air flow, 31B to the temperature control and 31C to control the direction of air flow of a car air-conditioner. In such an arrangement, an operation unit for controlling a car air-conditioner can be fabricated compact at a lower cost with a reduced number of constituent parts and components, yet the operation unit provides a superior feeling of operation.

In the above-described embodiments of multidirectional switches of the present invention, the wiring board 8 has been provided with independent push button switches 9A-9E, as the switching element, mounted on the upper surface thereof. However, it may be formed instead by providing fixed contact points made by printing and curing a conductive paste on the upper surface of the wiring board 8 and movable contacts made of metal, film or rubber, disposed opposing to the fixed contact points with a certain specific clearance in between. The movable contacts having been shaped in a dome-form so that they reverse with a snapping action against a pressing force applied thereon to generate a click feeling of operation. Further, the fixed contact points may be a made of conventional materials for contact points such as silver alloys.

What is claimed is:

1. A multidirectional switch comprising:
(a) a case having a support protruding from a center of a bottom;
(b) a swaying body having a bowl portion locating so that it can sway on said support of said case, said swaying body having an operating axle protruding from the center of the upper surface of said bowl portion;
(c) a plurality of switching contacts provided underneath said swaying body;
(d) a push means for pushing said plurality of switching contacts;
(e) a cover having an opening at the center for covering said case from above; and
(f) an operation body having a plurality of operating areas on the upper surface, said operation body having a coupling section protruding from a center of the lower surface thereof and being inserted through said opening of said cover to be fixed on said operating axle of said swaying body;
wherein, each of said operating areas is disposed at a region corresponding to the middle area between said plurality of switching contacts, and a pressing force applied on said operating area causes an up/down motion of said push means bringing two of the switching contacts into electrical connection/disconnection at the same time.

2. The multidirectional switch of claim 1, wherein said push means comprises a plurality of push sections provided as the integral part of said swaying body protruding in a radial arrangement from the outer circumference of said bowl portion of said swaying body.

3. The multidirectional switch of claim 1, wherein said push means is a plurality of push members inserted respectively in a plurality of through holes provided in a radial arrangement around said opening of said cover.

4. The multidirectional switch of claim 3, wherein said plurality of push members are connected with flexible arms into a single body.

5. The multidirectional switch of claim 1, wherein said plurality of switching contacts is installed in a plurality of push button switches.

6. The multidirectional switch of claim 1, wherein said plurality of switching contacts comprises printed and cured conductive paste.

7. An operation unit containing a plurality of multidirectional switches comprising;
(a) a case having a support protruding from a center of a bottom;
(b) a swaying body having a bowl portion locating so that it can sway on said support of said case, said swaying body having an operating axle protruding from the center of the upper surface of said bowl portion;
(c) a plurality of switching contacts provided underneath said swaying body;
(d) a push means for pushing said plurality of switching contacts;
(e) a cover having an opening at the center for covering said case from above; and
(f) an operation body having a plurality of operating areas on the upper surface, said operation body having a coupling section protruding from a center of the lower surface thereof and being inserted through said opening of said cover to be fixed on said operating axle of said swaying body;
wherein, each of said operating areas is disposed at a region corresponding to the middle area between said plurality of switching contacts, and a pressing force applied on said operating area causes an up/down motion of said push means bringing two of the switching contacts into electrical connection/disconnection at the same time,
wherein, said plurality of multidirectional switches being mounted in a framework with said operation body of the switches facing front.

8. The operation unit of claim 7, wherein said push means comprises a plurality of push sections provided as the integral part of said swaying body protruding in a radial arrangement from the outer circumference of said bowl portion of said swaying body.

9. The operation unit of claim 7, wherein said push means is a plurality of push members inserted respectively in a plurality of through holes provided in a radial arrangement around said opening of said cover.

10. The operation unit of claim 9, wherein said plurality of push members are connected with flexible arms into a single body.

11. The operation unit of claim 7, wherein said plurality of switching contacts is installed in a plurality of push button switches.

12. The operation unit of claim 7, wherein said plurality of switching contacts comprises printed and cured conductive paste.
